(19) United States
(12) Patent Application Publication
(10) Pub. No.: US 2011/0307835 A1
(43) Pub. Date: Dec. 15, 2011

(54) METHOD FOR DISPLAYING THUMBNAIL GROUP ON IDLE SCREEN AND MOBILE COMMUNICATION TERMINAL

(75) Inventors: Joohwan LIM, Seoul (KR); Youngmin Son, Seoul (KR); Hyeonjeong Kim, Busan (KR); Gidong Kim, Seoul (KR); Wooyong Choi, Seoul (KR); Saeyi Park, Seoul (KR)

(73) Assignee: SK TELECOM CO., LTD., Seoul (KR)

(21) Appl. No.: 12/964,443

(22) Filed: Dec. 9, 2010

(30) Foreign Application Priority Data
Jun. 9, 2008 (KR) 10-2008-053703
Jun. 9, 2008 (KR) 10-2008-0053712

(51) Int. Cl. G06F 3/048

(52) U.S. Cl. 715/838

(57) ABSTRACT

A method for displaying a thumbnail group on an idle screen and a mobile communication terminal are disclosed. The mobile communication terminal includes: a storage for storing a communication program; a terminal controller for executing the communication program; a display for displaying the communication program executed by the terminal controller; and an input unit for receiving commands from a user, wherein the terminal controller, through executing the communication program, controls to display a thumbnail group including frequent contacts on a certain portion of an idle screen, and upon receiving an activation command from the input unit, turn the screen to an active mode screen for displaying graphic image information of the frequent contacts, and in response to the input unit selecting a specific contact, display detailed information on the particular member in the contacts.

### CROSS-REFERENCE TO RELATED APPLICATION

This application claims the priorities of Korean Patent Application No. 10-2008-0053703, filed on Jun. 9, 2008 and Korean Patent Application No. 10-2008-0053712, filed on Jun. 9, 2008 in the KIPO (Korean Intellectual Property Office), the disclosures of which are incorporated herein in their entirety by reference. Further, this application is the National Phase application of International Application No. PCT/KR2009/003069, filed on Jun. 9, 2009, which designates the United States and was published in Korean. Each of these applications is hereby incorporated by reference in their entirety into the present application.

### TECHNICAL FIELD

The present disclosure relates to a method for displaying a thumbnail group on an idle screen and a mobile communication terminal. More particularly, the present disclosure relates to a method for displaying a thumbnail group on an idle screen with sharable status information and a mobile communication terminal wherein thumbnail information on a user's preset group of contact members is displayed on the idle screen of the mobile communication terminal and, in response to an activation key input, a active mode screen is outputted to indicate a frequent contacts group including information on one or more contact members, various added features are provided to help contacting a selected member, and not only an assistance is provided to facilitate contacting the members even further by reordering the information thumbnails displayed on the idle screen based on the member last contacted but also status information of the selected member is provided and, in response to changes in status information of the contact members preregistered with the frequent contacts group, the information thumbnails displayed on the idle screen are reordered so that the status information of the contact members is more recognizable.

### BACKGROUND ART

The statements in this section merely provide background information related to the present disclosure and may not constitute prior art.

The present time advancement of computer, electronics, and communication technologies has enabled a variety of wireless communication services with the help of wireless networks followed by the ubiquitous distribution of mobile communication terminals.

In general, the home screen or idle screen outputted on the screen display is an arbitrary default image as set by the manufacturer at its release.

The idle screen is a screen necessarily observed no matter what the terminal user does with the terminal such as a voice calling, using a short message service (SMS) or multimedia messaging service (MMS), playing an electronic game, or photographing, and it is customary that users set it to become photos of themselves, friends' photos, or their preferred images of Internet-downloaded celebrities, cars, etc. or videos.

Also outputted on the idle screen in general are user's set image or a video file, current consumption of the terminal power, strength of the radio wave reception, date, time, and receiving/sending status of text and voice messages.

However, an unavailability of an output of information on frequently contacted members or people of interest has left the users resort to the typical menu button to search through the prestored contact members or depress a send button to bring up a recent call list and check the receiving/sending status which is cumbersome.

In addition, the unavailability of information on frequently contacted members or people of interest meant the user had to make calls or do the texting around before getting to know the statuses of the contact members.

### DISCLOSURE

### Technical Problem

Therefore, the present disclosure has been made for providing a method for displaying a thumbnail group on an idle screen with sharable status information and a mobile communication terminal wherein thumbnail information on user's preset frequent contacts are displayed on the idle screen of the mobile communication terminal and, in response to an activation key input, an active mode screen is outputted to indicate a frequent contacts group including information on one or more contact members, various added functions are provided to help contacting a selected member, and not only an assistance is provided to facilitate contacting the members even further by reordering the information thumbnails displayed on the idle screen based on the member last contacted but also status information of the selected member is provided and, in response to changes in status information of the contact members preregistered with the frequent contacts group, the information thumbnails displayed on the idle screen are reordered so that the status information of the contact members is more recognizable.

### Technical Solution

One aspect of the present disclosure provides a mobile communication terminal including: a storage for storing a communication program; a terminal controller for executing the communication program; a display for displaying the communication program executed by the terminal controller; and an input unit for receiving commands from a user, wherein the terminal controller, through executing the communication program, controls to display a thumbnail group including frequent contacts on a certain portion of an idle screen, and upon receiving an activation command from the input unit, turn the screen to an active mode screen for displaying graphic image information of the frequent contacts, and in response to the input unit selecting a specific contact, display detailed information on the particular member in the contacts.

Another aspect of the present disclosure provides a method for displaying a thumbnail group including: displaying the thumbnail group including frequent contacts on a certain portion of an idle screen; upon receiving an activation command from an input unit, turning the screen into an active mode screen for displaying graphic image information of the frequent contacts; and in response to the input unit selecting a specific contact, displaying detailed information on the particular member in the contacts.

### Advantageous Effects

According to the disclosure as described above, the present disclosure enables the user to display thumbnail information on a user's preset group of contact members is displayed on an idle screen of the mobile communication terminal and, in response to an activation key input, output a active mode screen to indicate frequent contacts including information on one or more contact members matching with the thumbnail information, provide various added features to help contacting a selected member, and contact the members easier by reordering the thumbnail information display on the idle screen based on information on the member last contacted by the user.

The disclosure advantageously rotates the thumbnail group clockwise or counterclockwise to move a matching thumbnail with a selected member of the frequent contacts into a preset position of the thumbnail group so that the user quickly recognizes the member last contacted by the user.

In addition, the disclosure advantageously outputs detailed information on the selected member corresponding to the relocated thumbnail at the preset position of the thumbnail group, as a home screen output of the active mode screen so that it becomes more convenient for the user to communicate with frequently contacting members.

In addition, the disclosure advantageously responses to editing or changing graphic image information of the members by applying such edited or changed thumbnails to the thumbnail group so that many faces of contact members or family members can be outputted on the idle screen.

In addition, the disclosure advantageously outputs the thumbnail group on the idle screen by using one or more idle screen standards of WIPI, BREW, MIDP, SKVM, Mobile OS, Linux, and Rex platforms for applications to a variety of communication terminals.

In addition, the disclosure advantageously provides a contact mode icon list of one or more of a voice calling icon, a short message service (SMS) icon, and a multimedia instant message (MIM) icon so that the user can quickly contact the preset family members or contact members in various modes.

The present disclosure provides for displaying thumbnail information for a user's preset group of contact members and other's status information on the idle screen and, in response to an activation key input, outputs a active mode screen for indicating frequent contacts including information on one or more contact members, provides status information of the selected contact member and, in response to changes in status information of the contact members preregistered with the frequent contacts, reorder the thumbnails displayed on the idle screen so that the status information of the contact members is more recognizable.

Additionally, according to the disclosure, user's own status information is outputted on a certain portion of an idle screen and, upon receiving a preset status information changing key, the screen turns to a status information change page for setting incoming information as renewal status information before outputting it as the user's own status information, and a transport signal for the renewal status information is sent to the contact members' terminals preregistered with the frequent contacts group so that the user's own emotions or status information based on the current situation can be notified in real time to the contact members preregistered with the frequent contacts group.

Moreover, in response to a key input for deactivating the notice, the disclosure advantageously keeps the terminal mute from vibrations or alarm sounds even after receiving status information change signals while applying the received other's status information onto the active mode screen so that the user is not bothered from the pals' possible changes of status information at midnight hours.

In addition, the disclosure advantageously rotates the thumbnail group clockwise or counterclockwise to move a matching thumbnail with a status information change signal into a preset position of the thumbnail group, temporarily outputs the members' status information on the idle screen, and controls relocated thumbnail at the preset position to blink temporarily so that the preregistered members with the frequent contacts group can verify the status information in real time.

In addition, the present disclosure advantageously uses the status information change signals in a message push format so that the changes in the status information are possible by using a short message service infrastructure.

In addition, the present disclosure advantageously outputs a contact mode icon list for selected members and, in response to an input of a contact mode selection key for the contact mode icon list, performs an operation preset for the contact mode selection key to facilitate contacting the members with status information changed.

### DESCRIPTION OF DRAWINGS

FIG. 1 is a schematic block diagram for showing a mobile communication terminal for displaying a thumbnail group on an idle screen according to an aspect;

FIG. 2 is a flow diagram for describing a method for displaying a thumbnail group on an idle screen according to an aspect;

FIG. 3 is an exemplary diagram for showing an idle screen and a active mode screen with a thumbnail displayed according to an aspect;

FIG. 4 is an exemplary diagram for showing an idle screen and a active mode screen indicating user's own information according to an aspect;

FIG. 5 is a schematic block diagram for showing a system for sharing status information according to another aspect;

FIG. 6 is a schematic block diagram for showing a communication server according to another aspect;

FIG. 7 is a schematic block diagram for showing a mobile communication terminal for sharing status information according to another aspect;

FIG. 8 is a flow chart for explaining a method for the mobile communication terminal of another aspect to share the status information;

FIG. 9 is a flow chart for explaining a method for the communication server of another aspect to share the status information;

FIG. 10 is an exemplary diagram according to another aspect; and

FIG. 11 is an exemplary diagram of the format of a status information change signal according to another aspect.

### MODE FOR INVENTION

Hereinafter, aspects of the present disclosure will be described in detail with reference to the accompanying drawings. In the following description, the same elements will be designated by the same reference numerals although they are shown in different drawings. Further, in the following description of the present disclosure, a detailed description of known functions and configurations incorporated herein will be omitted when it may make the subject matter of the present disclosure rather unclear.

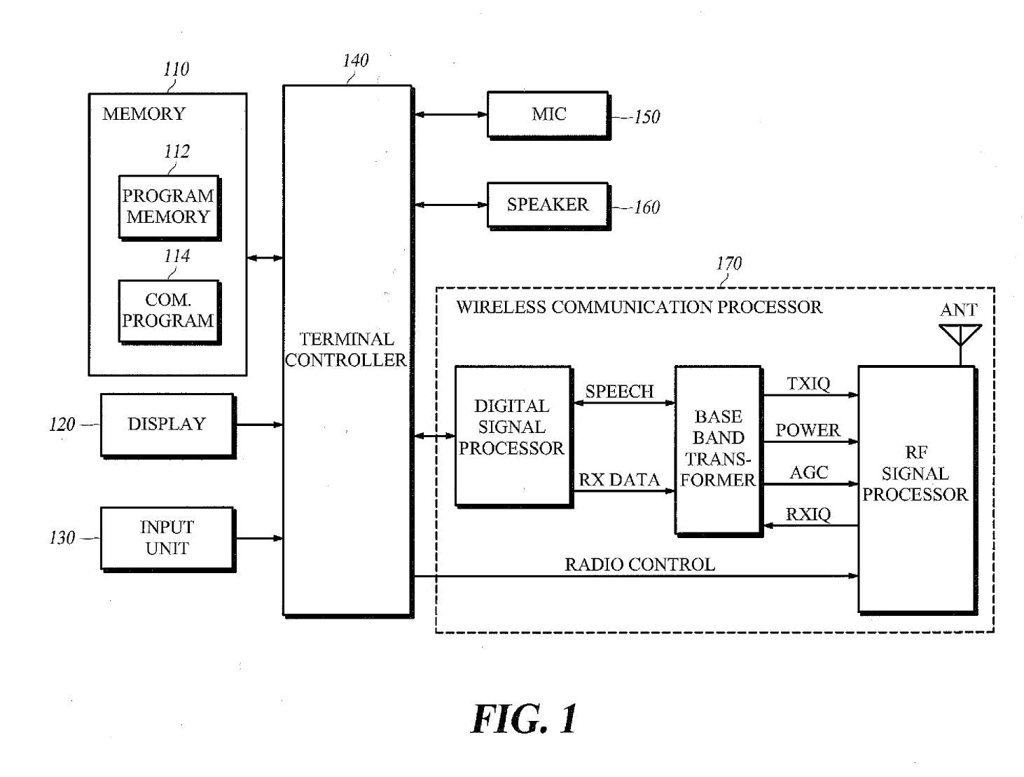

FIG. 1 is a schematic block diagram for showing a mobile communication terminal for displaying a thumbnail group on an idle screen according to an aspect.

The mobile communication terminal for displaying the thumbnail group on the idle screen includes a memory 110, a display 120, an input unit 130, a terminal controller 140, a microphone 150, a speaker 160, and a wireless communication processor 170.

The present disclosure recites the inclusion of memory 110, display 120, input unit 130, terminal controller 140, microphone 150, speaker 160, and wireless communication processor 170 although it is only illustrative and the mobile communication terminal components may be applied with changes and modifications as needed by a person skilled in the art.

Memory 110 is a means for storing basic software to drive the mobile communication terminal and perform voice and data communications, a number of software programs to carry out different functional features including a camera feature, and protocol software to process messages transmitted and received to perform wireless communications and the like.

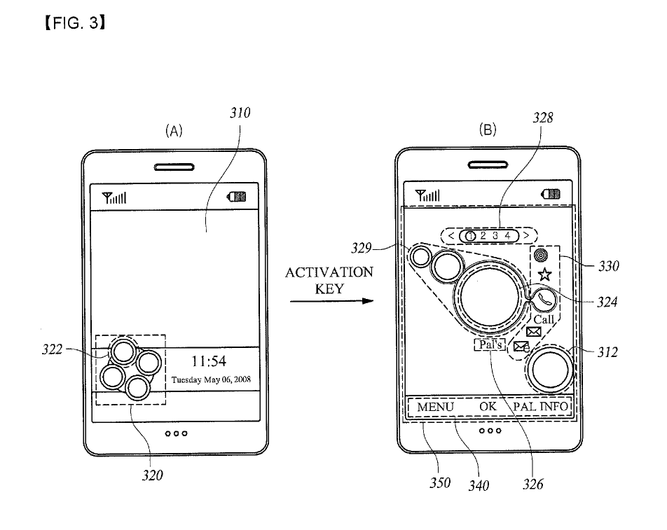

Memory 110 does a temporary storage of data generated through executing a terminal control program or stores user's input data, and it may be composed of a program memory 112 for controlling the general operation of the mobile communication terminal and a communication program 114 for outputting a group of thumbnails 320 or frequent contacts 329 shown in FIG. 3.

Here, communication program 114, an application installed in the mobile communication terminal, provides a page setting where user's frequent contact members or one or more acquaintances of interest may be grouped, functions to output the thumbnails for the graphic image information of the group members on the idle screen, rendering one or more thumbnail outputs on the idle screen as a single group, functions to reposition the thumbnails based on information of the member contacted by the user and, in response to an activation key input, provides a contact mode to assist with an easier contacting with preregistered members.

Active mode screen 350 herein commonly refers to a displayed page for setting user's frequent contact members or one or more acquaintances of interest and a page for outputting set members' image, name, and phone number information provided by communication program 114.

Frequent contacts 329 are defined as a group set as composed of user's frequent contact members or one or more acquaintances of interest in communication program 114.

In addition, thumbnail group 320 is defined as a grouped illustration of thumbnails for image information within information of the respective members in the frequent contacts 329. That is, thumbnail group 320 is an idle screen area displaying only thumbnails out of members' information set with the frequent contacts 329.

Meanwhile, communication program 114 may be implemented in a computer program for executing functions and by computer readable media with the program data recorded, the functions including having display 120 output idle screen 310 with its certain portion displaying thumbnail group 320 containing thumbnails 322 of the corresponding number to a preset number of slots, outputting active mode screen 350 to illustrate image information of the members in the frequent contacts 329 matching thumbnail group 320 in response to a preset activation key input and, if image information corresponding to a particular member is selected outputting detailed information of the selected member in the frequent contacts 329, outputting contact mode icon list 330 for the selected member, and if a contact mode selection key is inputted performing an operation preset in accordance with the same key.

Display 120 shows the state of operation of the mobile communication terminal including the usage of a power source, the strength of the radio signal reception, date, and time, and it becomes a display means for outputting information delivered in the forms of characters, numbers, images, etc.

Following terminal controller 140, display 120 also shows messages generated along the execution of the various programs stored in memory 110 and messages generated through the execution of communication program 114.

Input unit 130 is a key input means provided with numerical buttons, character input button, menu selection buttons and the like for receiving key inputs or commands from the mobile communication terminal user.

Terminal controller 140 is to control the overall operations of the mobile communication terminal and executes the various programs stored in memory 110 for not only the basic function of voice and data communications according to inputted signals from input unit 130 or wireless communication processor 170 but also added functions. In addition, upon receiving data having no immediacy in execution, terminal controller 140 has such data sent to and stored in memory 110.

According to an aspect, terminal controller 140 follows communication program 114 to perform controls of outputting thumbnail group 320 containing thumbnails 322 of the corresponding number to a preset number of slots on a certain portion of idle screen 310 and, if the preset activation key is inputted, turning the screen to active mode screen 350 for displaying graphic images of members of frequent contacts 329 matching thumbnail group 320, and in response to selecting the image information corresponding to the particular member, outputting the detailed information on the particular selected member in the frequent contacts 329, outputting contact mode icon list 330 for the selected member, and if a contact mode selection key for contact mode icon list 330 is inputted, performing an operation preset in accordance with the same key.

Here, the detailed information on the member includes member's image information 324, name information 326, phone number information, email information, and address information.

At the same time, thumbnail group 320 is formed of thumbnails 322 equally numbered to preset slots connected in a vertical or horizontal oval shape.

In addition, terminal controller 140 according to an aspect controls to rotate thumbnail group 320 clockwise or counterclockwise to move the image information of the selected member of frequent contacts 329 into a preset position of thumbnail group 320. Here, the preset position may be the uppermost or lowermost in thumbnail group 320.

When the preset activation key is inputted from input unit 130, terminal controller 140 according to an aspect controls the image information of the member of thumbnail group 320 who has moved to the preset position to be outputted as a home screen of active mode screen 350.

Upon receiving the preset activation key from input unit 130, terminal controller 140 according to an aspect controls to output audio or animated effects associated with the relocated thumbnail at the preset position in thumbnail group 320, and then output the image information of the member corresponding to the relocated thumbnail as a home screen of active mode screen 350.

For example, in response to the preset activation key input, terminal controller 140 may control to emit a sound like ‘pororon’ implying the linkage between thumbnail group 320 and active mode screen 350 and/or output an animated effect on the relocated thumbnail at the preset position in thumbnail group 320 to be rotated clockwise or counterclockwise coupled with a fade-out.

In addition, upon receiving a preset deactivation key from input unit 130, terminal controller 140 according to an aspect controls to turn active mode screen 350 to idle screen 310 as it controls a matching thumbnail with the image information of the last selected member from active mode screen 350 to move to a preset position of thumbnail group 320 to thereby highlight the selected member.

When active mode screen 350 is turned to idle screen 310 with receiving the preset deactivation key from input unit 130, another input of the preset activation key from input unit 130 renders the image information of the last member selected from active mode screen 350 to be outputted as a home screen.

Terminal controller 140 according to an aspect controls to output a soft key 340 for allowing the detailed information on the selected member to be edited on active mode screen 350.

Terminal controller 140 also performs to output an idle screen thumbnail 312 on a certain portion of active mode screen 350.

Here, member's image information 324 may be set using a photograph, avatar, or character, and in the case where member's image information 324 is edited, terminal controller 140 performs to apply the edited or changed thumbnails to thumbnail group 320. Terminal controller 140 also performs to set others' photos received or shared through wireless communication processor 170 as member's image information 324.

In addition, terminal controller 140 according to an aspect controls to output thumbnail group 320 on idle screen 310 by using one or more idle screen standards of WIPI, BREW, MIDP, SKVM, Mobile OS, Linux, and Rex platforms.

Here, the contact mode icon list includes one or more of a voice calling icon, a short message service (SMS) icon, a multimedia messaging service (MMS) icon, and a multimedia instant message (MIM) icon.

Terminal controller 140 also performs to output a slot number at 328, which represents the total number of frequent contacts 329 matching the preset number of slots of thumbnail group 320 on active mode screen 350.

Terminal controller 140 also performs to incorporate the user's own information into frequent contacts 329 and then display thereof on active mode screen 350.

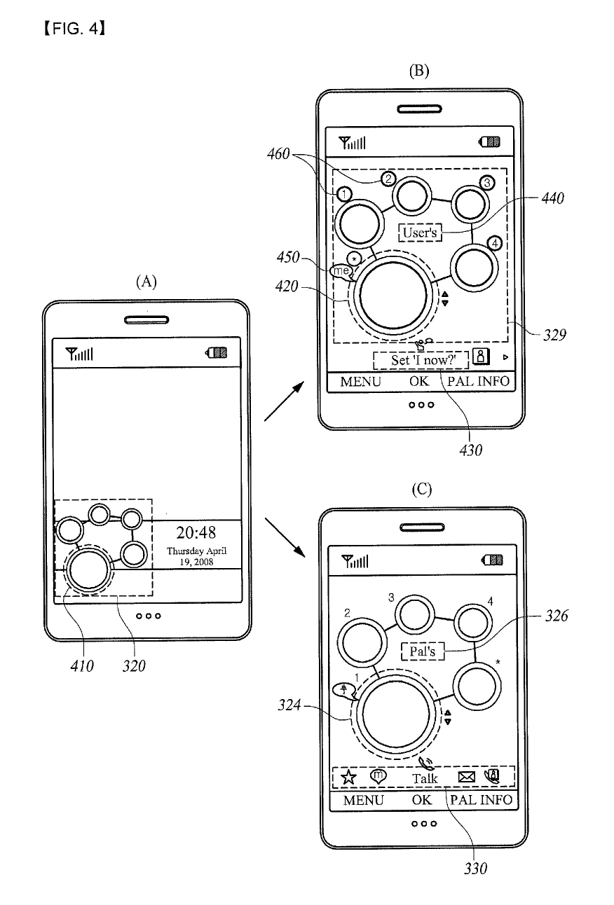

Terminal controller 140 also performs to have active mode screen 350 show separator information or a tag 450 for differentiating user's own information from the preregistered members with frequent contacts 329 as in FIG. 4.

Here, the user's own information may include one or more of user's own image information 420, name information 440, and status change information 430, which may include an editing function of the user's photo or a changing function of the user's status.

Terminal controller 140 also performs a rendering of user's own image information 420 in a different borderline color or pattern from the preregistered members for a further differentiation therebetween.

Terminal controller 140 also performs to incorporate a thumbnail 410 for user's own image information 420 into thumbnail group 320.

Microphone 150 is a voice input means adapted to transform a mobile communication subscriber's voice input into an electric signal to supply.

Speaker 160 is a means for transforming the supplied voice signal into audible sounds to output.

Wireless communication processor 170 is a means for processing wireless communications by performing a digital signal processing function including audio signal coding/decoding, an equalizer feature for canceling a multipath noise, and audio data processing; a baseband transform function including a transform of transmitted/received signals to the baseband signals and a digital-to-analog and analog-to-digital transforms; an RF signal processing function including receiving and transforming a radio frequency (RF) signal to an intermediate frequency (IF) signal, and demodulating and amplifying the RF signal; and an antenna feature for transceiving wireless signals over the air.

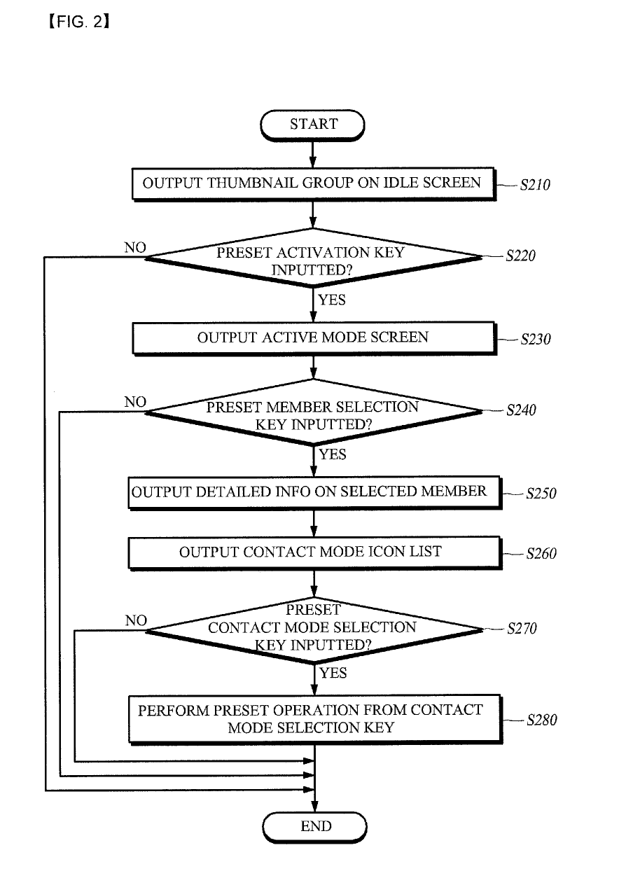

FIG. 2 is a flow diagram for describing a method for displaying a thumbnail group on an idle screen according to an aspect.

The mobile communication terminal outputs idle screen 310 on display 120 and follows communication program 114 to show thumbnail group 320 of thumbnails 322 numbered equally to a predetermined number of slots on a certain portion of idle screen 310 in step S210.

The mobile communication terminal checks if a preset activation key is inputted from input unit 130 in step S220.

For example, assuming the preset key is a ‘cancel key’, the mobile communication terminal determines if the user operates input unit 130 to enter the ‘cancel key’.

When step S220 finds the preset activation key inputted, the terminal outputs active mode screen 350 that displays the image information of one or more members of frequent contacts 329 matching thumbnail group 320 in step S230.

Here, the detailed information on the member includes member's image information 324, name information 326, or both.

The terminal checks if a preset member selection key is inputted from input unit 130 in step S240.

For example, assuming the preset member selection key is ‘left/right arrow keys’, the terminal determines if the user had an operation on input unit 130 to input the ‘left/right arrow keys’.

When step S240 finds the preset activation key inputted, the terminal outputs the detailed information on the selected member of frequent contacts 329 in step S250.

The terminal outputs contact mode icon list 330 for the selected member in step S260.

The terminal determines in step S270 if there is an input of a contact mode selection key which is preset for contact mode icon list 330.

For example, assuming the preset member selection key is ‘up/down arrow keys’, the terminal determines if the user had an operation on input unit 130 to input the ‘up/down arrow keys’.

Here, since contact mode icon list 330 includes one or more of the voice calling icon, SMS icon, MMS icon, and MIM icon, the user's operation of input unit 130 to input the ‘up/down arrow keys’ will accordingly select one of the voice calling icon, SMS icon, MMS icon, and MIM icon.

When step S270 finds the preset contact mode selection key inputted, the terminal performs preset operations responding to the contact mode selection key in step S280.

Specifically, as a response to the user's operation of input unit 130 to input the ‘up/down arrow keys’, assuming the accordingly selected icon to be the ‘voice calling icon’, the terminal may transmit the voice call to the phone number corresponding to the selected member, while assuming the selected icon to be the ‘SMS icon’, the terminal may transmit the SMS to the same member's phone number.

FIG. 3 is an exemplary diagram for showing an idle screen and a active mode screen with a thumbnail displayed according to an aspect.

Idle screen 310 in FIG. 3 at A is adapted to output images that the users set with their own photos, friends' photos, or their preferred images such as those of Internet-downloaded celebrities, cars, etc. or videos.

According to an aspect, along with the user's set image or video on idle screen 310, the terminal outputs thumbnail group 320 containing thumbnails 322 of the corresponding number to a preset number of slots on a certain portion of idle screen 310.

The position of thumbnail group 320 in FIG. 3 at A is merely to illustrate the technical idea of the disclosure, and it may be varied within idle screen 310 by a person skilled in the technical area of the present disclosure without departing from the essential characteristics of the disclosure.

In addition, upon inputting the preset activation key in the state of FIG. 3 at A, active mode screen 350 is outputted as in FIG. 3 at B.

Active mode screen 350 contains idle screen thumbnail 312, member's image information 324, name information 326, slot number 328, frequent contacts 329, contact mode icon list 330, and soft key 340.

Idle screen thumbnail 312 may be a thumbnail dedicated to idle screen 310 and outputted at a certain portion of active mode screen 350.

Member's image information 324 may be set using a photograph, avatar, or character, and edited by the user through soft key 340. In addition, image information 324 may be set with others' photos received or shared through wireless communication processor 170.

Members' name information 326 represents an area to output the user's name data registered with frequent contacts 329 and it may show the user's name and group name registered with a directory of numbers in the terminal.

Slot number 328 represents an area to indicate the total number of frequent contacts 329 that corresponds to the preset slot number of thumbnail group 320, and if four are the total members of frequent contacts 329 in FIG. 3 at B, slot number 328 may be depicted as ‘1 2 3 4’. In addition, the respective numbers corresponding to the members may be distinctively colored.

Frequent contacts 329 match the preset slot number of thumbnail group 320 and is a group containing the user's preset members.

Contact mode icon list 330 is an area to provide various icons in a list for allowing contacts with other subscribing users corresponding to the selected members.

As shown in FIG. 3 at B, soft key 340 provides a function to select ‘MENU’, ‘OK’, and ‘PAL INFO’, which when selected by the user provides a function to edit, change, or correct the selected member's detailed information as illustrated.

FIG. 4 is an exemplary diagram for showing an idle screen and an active mode screen indicating user's own information according to an aspect.

As shown in FIG. 4 at B, the mobile communication terminal provides the active mode screen where the user's own information is additionally contained in frequent contacts 329, which may also show shortcut key information 460 as well as tag 450 for differentiating the user's information from the preregistered members' with frequent contacts 329.

Here, FIG. 4 at B also shows that the user's own information may include one or more of user's own image information 420, name information 440, and status change information 430, which may include an editing function of the user's photo or a changing function of the user's status.

In order to differentiate user's own image information 420 from the preregistered members' image information, the mobile communication terminal may add a distinctive borderline color or pattern, which is distinctive from the preregistered members.

On the active mode screen as at B of FIG. 4, when there is an input of the selection key (‘up/down arrow keys’) for the preset contact mode, the detailed information of the selected member and contact mode icon list 330 may be outputted in the frequent contacts 329 as shown at C of FIG. 4.

As is also shown at B of FIG. 4, shortcut key information 460 matches the user's own information as well as the preregistered members' image information in frequent contacts 329 and it may be outputted on a certain portion of idle screen 310 as shown.

As shown at B of FIG. 4 for example, it is possible to output the preregistered members' image information with active mode screen 350 plus shortcut key information 460 represented by marks ‘*’ over the user, ‘1, 2, 3 and 4’. In particular, the user's image information may be marked with ‘*’ while marks ‘1, 2, 3, and 4’ may be matched with the preregistered members' image information before their display output.

When a key from input unit 130 is received corresponding to shortcut key information 460, the preregistered members' information with frequent contacts 329 and the user's information may be rearranged in order to centrally position the user's information or the image information of the member of frequent contacts 329 who matches the key corresponding to shortcut key information 460.

In particular, if the user depresses ‘3’ among shortcut information 460 of ‘*, 1, 2, 3 and 4’, the member marked with ‘3’ may be centered by a clockwise or counterclockwise rotation of the preregistered members' and user's information. On the other hand, as shown at A of FIG. 4, the terminal may additionally display thumbnail 410 for the user's own image information onto thumbnail group 320.

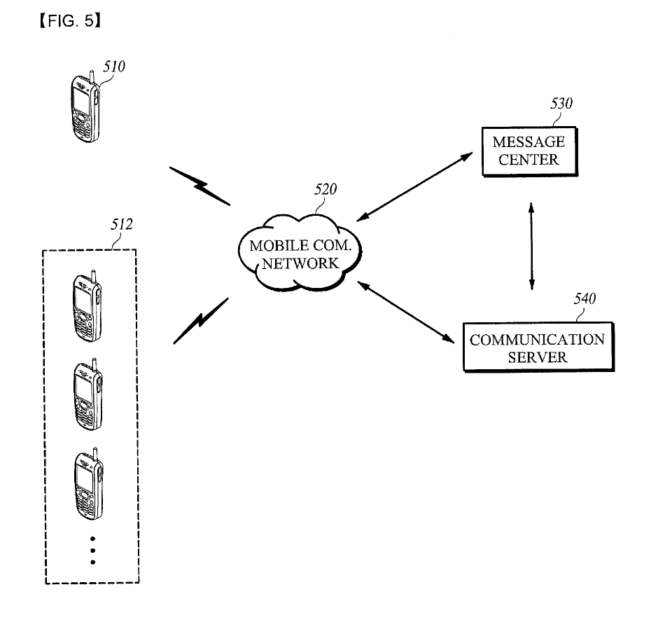

FIG. 5 is a schematic block diagram for showing a system for sharing status information according to another aspect.

The sharing system includes a mobile communication terminal 510, different mobile communication terminals 512, a mobile communication network 520, message center 530, and a communication server 540.

Terminal 510 and different terminals 512 are adapted to perform the typical voice calling and data communications in association with mobile communication network 520.

Terminals 510 and 512 are also loaded with a communication program, which is assumed for the purpose of description to direct the communications among terminals 510 and 512.

Mobile communication terminal 510 according to the second aspect follows a communication program 714 to output a thumbnail group 1020 of thumbnails 1022 of the corresponding number to a preset number of slots on a certain portion of an idle screen 1010 and, if a preset activation key is inputted, turn the screen to a active mode screen for displaying among matching frequent contacts 1028 with thumbnail group 1020 at least one member's and other's status information 1030, and, if a preset member selection key is inputted, output among frequent contacts 1028 the selected member's and other's status information.

Mobile communication terminal 510 according to the second aspect performs to output on a certain portion of active mode screen 1050.

Mobile communication terminal 510 according to the second aspect, upon receiving a preset status information change key to change user's own status information 1040, turns the screen to a status information change page and then sets inputted information as renewed status information and outputs it as user's status information 1040.

Mobile communication terminal 510 according to the second aspect, in response to the setting of the renewed status information, supplies communication server 540 with a transport signal for sending to the different terminals preregistered with frequent contacts 1028.

Different mobile communication terminals 512 according to the second aspect follow communication program 714 to output a thumbnail group 1020 of thumbnails 1022 of the corresponding number to a preset number of slots on a certain portion of its idle screen 1010 and, if a preset activation key is inputted, turn the screen to a active mode screen for displaying among matching frequent contacts 1028 with thumbnail group 1020 at least one member's and other's status information 1030 and, if a preset member selection key is inputted, output among frequent contacts 1028 the selected member's and other's status information but, if a status information change signal is received, change the selected member's and other's status information to member's and other's status information received and corresponding to the status information change signal.

In addition, different mobile communication terminal 512 according to the second aspect outputs a preset vibration or audio notice once it receives the status information change signal.

In addition, different mobile communication terminal 512 according to the second aspect may respond to a key input for deactivating the notice for keeping the terminal mute from the vibrations or audio notice even after receiving the status information change signal while applying the received other's status information onto active mode screen 1050.

For example, when the user does not want to be bothered in the night from the status information change signal causing the vibrations or audio notice, the notice deactivation key may be inputted to stop generating the vibrations or audio notice even at the input of the status information change signal.

In addition, different mobile communication terminal 512 according to the second aspect outputs an animation effect associated with the received other's status information.

For example, different mobile communication terminal 512 according to the second aspect may make the changed other's status information in the frequent contacts 1028 noticeable by providing the informative characters with an animated firework effect.

In addition, different mobile communication terminal 512 according to the second aspect outputs a preset vibration or audio notice depending on when it receives the status information change signal.

In addition, different mobile communication terminal 512 responses to a receipt of the status information change signal in the night for limiting the vibrations and audio notice from being issued, but it applies the received status information onto active mode screen 1050.

Additionally, thumbnail group 1020 displayed on idle screen 1010 has thumbnails 1022 equally numbered to preset slots and connected in a vertical or horizontal oval shape.

Different mobile communication terminal 512 rotates thumbnail group 1020 clockwise or counterclockwise to move the corresponding thumbnail to the status information change signal into a preset position within thumbnail group 1020. Here, the preset position may be the uppermost or lowermost in thumbnail group 320.

Different mobile communication terminal 512 temporarily outputs the received other's status information on idle screen 1010.

Different mobile communication terminal 512 has the relocated thumbnail at the preset position blink temporarily.

Different mobile communication terminal 512, upon receiving at least one status information change signal, rotates thumbnail group 1020 clockwise or counterclockwise to move the corresponding thumbnail to the last status information change signal received into a preset position within thumbnail group 1020.

Different mobile communication terminal 512, upon receiving the preset activation key inputted, outputs the active mode screen for displaying the received member's and other's status information as a home screen.

Different mobile communication terminal 512, upon receiving one or more status information change signals, sequentially applies one or more others' status information received onto its active mode screen in which the corresponding member's and other's status information to the last received status information change signal among the status information change signals is outputted as a home screen.

Different mobile communication terminal 512, at the initial output of the home screen, temporarily blinks the selected member's or other's status information outputted on the home screen.

Hence, if the user missed checking the received other's status information in active mode screen 1050, briefly blinking the selected member's or other's status information outputted first on the home screen will facilitate discriminating it from the previously checked other's status information.

Different mobile communication terminal 512 also outputs a contact mode icon list 1060 for the selected member or received member and, in response to the input of the contact mode selection key for contact mode icon list 1060, performs a operation preset for the key. Here, the contact mode icon list includes one or more of a voice calling icon, an SMS icon, an MMS icon, and an MIM icon.

Here, the status information change signals are in an 80-byte message push format made of a header of 16 bytes that contains terminal driving platform allocation information and a body of 64 bytes containing application allocation information.

Here, the other's status information includes one or more of image icons, commonly used phrases, and 8-character texts or a combination of these.

In other words, the other's status information not only comprises the text format but also presents status information image icons and the commonly used phrases combined to express emotions beyond texts.

Here, status information image icons may comprise a variety of icons to show feelings or emotions which cannot be expressed through texts. Meanwhile, the commonly used phrases may comprise approximately twelve different expressions frequently used by the user who can then easily select one instead of trying to type in the texts.

Here, the detailed information on the member includes one or more of the member's image information at 1024, name information 1026, and phone number information.

Mobile communication network 520 is adapted to provide wireless connections among mobile communication terminal 510 and different mobile communication terminals 512 and offers various services including the voice communication service, wireless data service, wireless Internet service, and video calling or messaging service.

Message center 530 delivers the status information change signal requested in association with mobile communication network 520 to different mobile communication terminal 512 preregistered with frequent contacts 1028. If the requested status information change signal is failed to be delivered to different mobile communication terminal 512 because it's shut off from communication, message center 530 stores the requested status information change signal temporarily until different mobile communication terminal 512 resumes the communication. If the recovered different mobile communication terminal 512 has sent the requested status information change signal, message center 530 erases the temporary storage of the status information change signal upon receiving a signal for confirming its receipt by different mobile communication terminal 512. Message center 530 also deletes the status information change signal after a lapse of time or its designated effective delivery time for the signal.

In the implementation of the disclosure, message center 530 is preferably realized by a shortcut message service or SMS center.

Communication server 540 according to the second aspect receives the status information change signal, extracts one or more different terminals' information that preregistered mobile communication terminal 510 with frequent contacts 1028, and sends the status information change signal to different mobile communication terminals 512 corresponding to the extracted the different terminals' information.

In addition, communication server 540 according to the second aspect sends a sharing consent message for the status information to different mobile communication terminal 512 and, in response to an approval signal received for the sharing consent message from different mobile communication terminal 512, sends the status information change signal to different mobile communication terminal 512.

In addition, communication server 540 according to the second aspect transmits the sharing consent message only once to respective terminals corresponding to the one or more different terminals' information preregistered with frequent contacts 1028.

Communication server 540 according to the second aspect also performs to cancel the sharing consent for the terminals released from the registration with frequent contacts 1028.

In addition, communication server 540 according to the second aspect cooperates with a messenger server (not shown) to send a user name change signal or a status selection signal received from the messenger server to different mobile communication terminal 512.

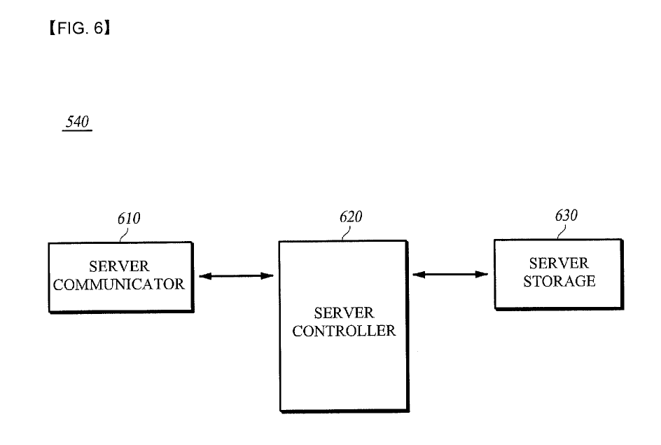

FIG. 6 is a schematic block diagram for showing a communication server according to a second aspect.

Communication server 540 according to the second aspect comprises a server communicator 610, a server controller 620, and a server storage 630.

Although communication server 540 is described with just server communicator 610, server controller 620, and server storage 630 to illustrate the technical idea of the disclosure, its components may be variably modified for application by a person skilled in the technical area of the present disclosure without departing from the essential characteristics of the disclosure.

Server communicator 610 works in concert with message center 530, mobile communication terminal 510, and different mobile communication terminal 512 to send and receive various signals.

Server controller 620 according to the second aspect is a total server function control for controlling server communicator 610 to receive the status information change signal from mobile communication terminal 510, extracts one or more different terminals' information that preregistered mobile communication terminal 510 with frequent contacts 1028, and sends the status information change signal to different mobile communication terminals 512 corresponding to the extracted the different terminals' information.

In addition, server controller 620 according to the second aspect controls server communicator 610 to send the sharing consent message for the status information to different mobile communication terminal 512 and, in response to the approval signal received for the sharing consent message from different mobile communication terminal 512, sends the status information change signal to different mobile communication terminal 512.

In addition, server controller 620 according to the second aspect controls server communicator 610 to transmit the sharing consent message only once to the respective terminals corresponding to the one or more different terminals' information preregistered with frequent contacts 1028.

Server controller 620 according to the second aspect also controls to perform canceling the sharing consent for the terminals released from the registration with frequent contacts 1028.

In addition, communication server 540 according to the second aspect controls server communicator 610 to cooperate with the messenger server (not shown) to send the user name change signal or a status selection signal received from the messenger server to different mobile communication terminal 512.

Server storage 630 is a means for storing various data needed to drive the server and functions to store on or both of the status information change signal and the different terminals' information.

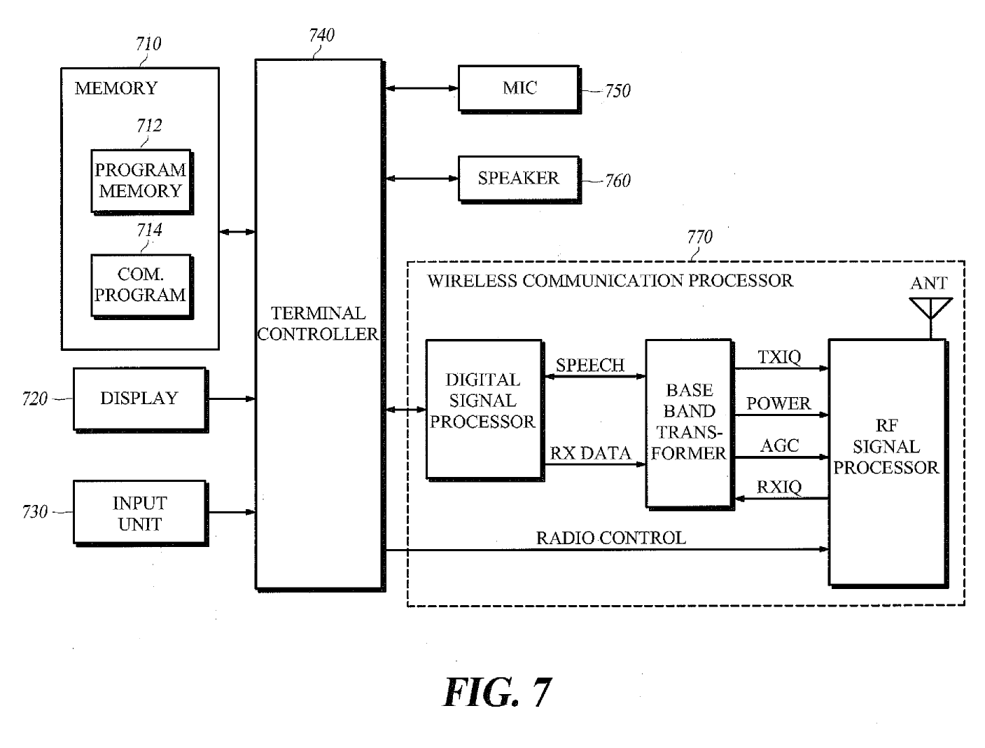

FIG. 7 is a schematic block diagram for showing a mobile communication terminal for sharing status information according to the second aspect.

Mobile communication terminal for sharing status information according to the second aspect may become mobile communication terminal 510 or different mobile communication terminal 512 shown in FIG. 5, but in FIG. 7 they are commonly called the mobile communication terminal as a comprehensive definition.

The mobile communication terminal includes a memory 710, a display 720, an input unit 730, a terminal controller 740, a microphone 750, a speaker 760, and a wireless communication processor 770.

Although mobile communication terminal includes memory 710, display 720, input unit 730, terminal controller 740, microphone 750, speaker 760, and wireless communication processor 770 to illustrate the technical idea of the disclosure, its components may be variably modified for application by a person skilled in the technical area of the present disclosure without departing from the essential characteristics of the disclosure.

Memory 710 is a means for storing basic software to drive the mobile communication terminal and perform voice and data communications, a number of software programs to carry out different functional features including a camera feature, and protocol software to process messages transmitted and received to perform wireless communications and the like.

Memory 710 performs a temporary storage of data generated through executing a terminal control program or stores user's input data, and it may be composed of a program memory 712 for controlling the general operation of the mobile communication terminal and a communication program 714 for outputting a thumbnail group 1020, frequent contacts 1028, or others' status information 1030.

Here, communication program 714, an application installed in the mobile communication terminal, provides a page setting where user's frequent contact members or one or more acquaintances of interest may be grouped, functions to output the thumbnails for the graphic image information of the group members on the idle screen, rendering one or more thumbnail outputs on the idle screen as a single group, functions to reposition the thumbnails based on information of the member contacted by the user and, in response to an activation key input, helps to facilitate recognizing the members with changed status information, and it is simply called the communication program.

Active mode screen 1050 herein commonly refers to a displayed page for setting user's frequent contact members or one or more acquaintances of interest, a page for outputting set members' image, name, and phone number information, and a page for outputting other's status information and user's status information provided by communication program 714.

In the present disclosure, frequent contacts 1028 are defined as a group set as composed of user's frequent contact members or one or more acquaintances of interest in communication program 114.

In addition, thumbnail group 1020 is defined as a grouped illustration of thumbnails for image information within information of the respective members in frequent contacts 1028. That is, thumbnail group 1020 is an idle screen area displaying only thumbnails out of members' information set with the frequent contacts 1028.

Meanwhile, communication program 714 may be implemented in a computer program for executing functions and by computer readable media with the program data recorded, the functions including outputting on a certain portion of idle screen 1010 a thumbnail group 1020 containing thumbnails 1022 of the corresponding number to a preset number of slots, outputting a active mode screen to illustrate at least one member's and others' status information 1030 in the frequent contacts 1028 matching thumbnail group 1020 in response to a preset activation key input, outputting selected member's and others' status information in the frequent contacts 1028 in response to a preset member selection key input and, if a status information change signal is inputted, changing the selected member's and other's status information into received member's and other's status information corresponding to the status information change signal and outputting the same.

Display 720 shows the state of operation of the mobile communication terminal including the usage of a power source, the strength of the radio signal reception, date, and time, and it becomes a display means for outputting information delivered in the forms of characters, numbers, images, etc.

Following terminal controller 740, display 720 also shows messages generated along the execution of the various programs stored in memory 710 and messages generated through the execution of communication program 714.

Input unit 730 is a key input means provided with numerical buttons for inputting telephone numbers or the like, character input button, menu selection buttons and the like for receiving key inputs or commands from the mobile communication terminal user.

Terminal controller 740 is to control the overall operations of the mobile communication terminal and executes the various programs stored in memory 710 for not only the basic function of voice and data communications according to inputted signals from input unit 730 or wireless communication processor 770 but also added functions. In addition, upon receiving data having no immediacy in execution, terminal controller 740 has such data sent to and stored in memory 710.

According to an aspect, terminal controller 740 follows communication program 714 to perform controls of outputting thumbnail group 1020 containing thumbnails 1022 of the corresponding number to a preset number of slots on a certain portion of idle screen 1010 and, if the preset activation key is inputted, turning the screen to the active mode screen for displaying at least one member's and other's status information 1030 matching thumbnail group 1020, and in response to a preset member selection key, outputting selected member's and others' status information in the frequent contacts 1028 in response to a preset member selection key input and, if a status information change signal is inputted, changing the selected member's and other's status information into received member's and other's status information corresponding to the status information change signal and outputting the same.

In addition, terminal controller 740 according to the second aspect controls to output user's status information 1040 to a preset number of slots on a certain portion of active mode screen 1050.

In addition, upon receiving a preset status information change key for changing user's own status information 1040, terminal controller 740 according to the second aspect controls to turn the screen to a status information change page and then set the incoming information as user's own status information 1040.

Terminal controller 740 according to the second aspect controls, in response to the setting of the renewed status information, to supply communication server 540 with a transport signal for transmitting the renewed status information to the different terminals preregistered with frequent contacts 1028.

In addition, upon receiving the status information change signal, terminal controller 740 according to the second aspect controls to output a preset vibration or audio notice.

In addition, terminal controller 740 according to the second aspect controls to respond to a key input for deactivating the notice for keeping the terminal mute from the vibrations or audio notice even at receiving the status information change signal while applying the received other's status information onto active mode screen 1050.

For example, when the user does not want to be bothered in the night from the status information change signal causing the vibrations or audio notice, the notice deactivation key may be inputted to stop generating the vibrations or audio notice even at the input of the status information change signal.

In addition, terminal controller 740 according to the second aspect controls to output an animation effect associated with the received other's status information.

For example, terminal controller 740 may make the changed other's status information in the frequent contacts 1028 noticeable by providing the informative characters with an animated firework effect.

In addition, terminal controller 740 according to the second aspect controls to rotate thumbnail group 1020 clockwise or counterclockwise to move the corresponding thumbnail to the status information change signal into a preset position within thumbnail group 1020.

Terminal controller 740 according to the second aspect also controls to temporarily output the received other's status information on idle screen 1010.

Terminal controller 740 according to the second aspect also has the relocated thumbnail at the preset position blink temporarily.

Terminal controller 740 according to the second aspect also controls, upon receiving at least one status information change signal, to rotate thumbnail group 1020 clockwise or counterclockwise to move the corresponding thumbnail to the last status information change signal received into a preset position within thumbnail group 1020.

Terminal controller 740 according to the second aspect, upon receiving the preset activation key inputted, also outputs the active mode screen for displaying the received member's and other's status information as a home screen.

Terminal controller 740 according to the second aspect, upon receiving one or more status information change signals, sequentially applies one or more others' status information received onto its active mode screen in which the corresponding member's and other's status information to the last received status information change signal among the status information change signals is outputted as a home screen.

Terminal controller 740 according to the second aspect, at the initial output of the home screen, also controls to temporarily blink the selected member's or other's status information outputted on the home screen.

Terminal controller 740 according to the second aspect also outputs a contact mode icon list 1060 for selected members or received members and, in response to an input of a contact mode selection key for contact mode icon list 1060, performs an operation preset for the contact mode selection key.

Microphone 750 is a voice input means adapted to transform a mobile communication subscriber's voice input into an electric signal to deliver. Speaker 760 is a means for transforming the supplied voice signal into audible sounds to output.

Wireless communication processor 770 is a means for processing wireless communications by performing a digital signal processing function including audio signal coding/decoding, an equalizer feature for canceling a multipath noise, and audio data processing; a baseband transform function including a transform of transmitted/received signals to the baseband signals and a digital-to-analog and analog-to-digital transforms; an RF signal processing function including receiving and transforming a radio frequency (RF) signal to an intermediate frequency (IF) signal, and demodulating and amplifying the RF signal; and an antenna feature for transceiving wireless signals over the air.

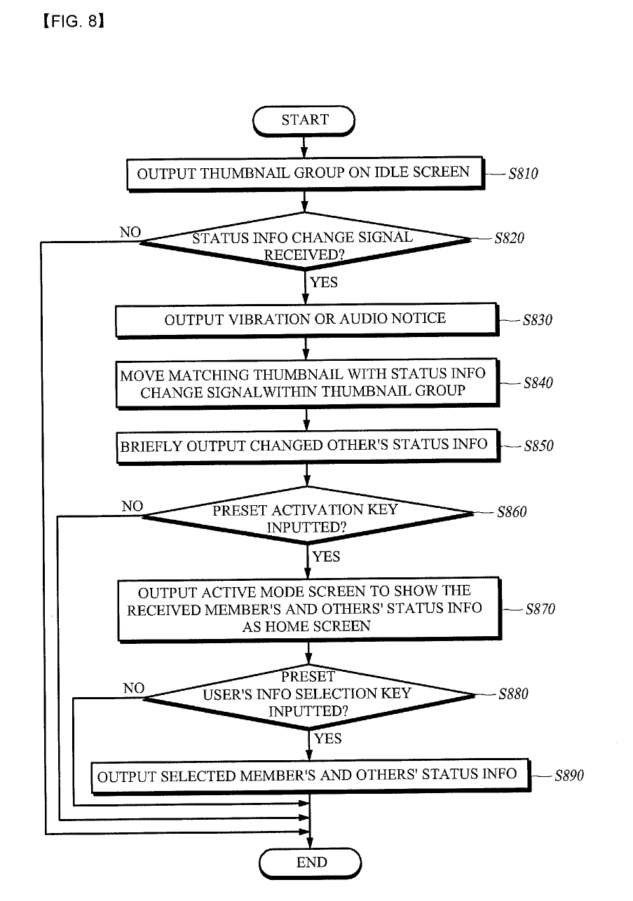

FIG. 8 is a flow chart for explaining a method for the mobile communication terminal of another aspect to share the status information.

Different mobile communication terminal 512 outputs idle screen 1010, a certain portion of which outputs thumbnail group 1020 containing thumbnails 1022 of the corresponding number to a preset number of slots in step S810.

Different mobile communication terminal 512 checks if there is a status information change signal received via message center 530 from communication server 540 in step S820.

If step S820 finds the status information change signal received, different mobile communication terminal 512 outputs a preset vibration or audio notice depending on when it receives the status information change signal instep S830.

Different mobile communication terminal 512 rotates thumbnail group 1020 clockwise or counterclockwise to move the corresponding thumbnail to the status information change signal into a preset position within thumbnail group 1020 in step S840.

Different mobile communication terminal 512 temporarily outputs the other's status information on a certain portion of idle screen 1010 in step S850.

For example, other's status information 1030 outputted on idle screen 1010 may be moved from the left to right and then faded out.

Different mobile communication terminal 512 checks if a preset activation key is inputted in step S860.

For example, assuming the preset key is a ‘cancel key’, different mobile communication terminal 512 determines if the user operates input to enter the ‘cancel key’.

When step S860 finds the preset activation key input, different mobile communication terminal 512 outputs active mode screen 1050 that displays its home page of member's and others' status information received and corresponding to the status information change signal in frequent contacts 1028 matching thumbnail group 1020 in step S870.

Different mobile communication terminal 512 checks if a preset member selection key is inputted in step S880.

For example, assuming the preset member selection key is left/right arrow keys', different mobile communication terminal 512 determines if the user had an operation on input for the ‘left/right arrow keys’.

When step S880 finds the preset member selection is inputted, different mobile communication terminal 512 outputs selected member's and others' status information in frequent contacts 1028 in response to the member selection key in step S890.

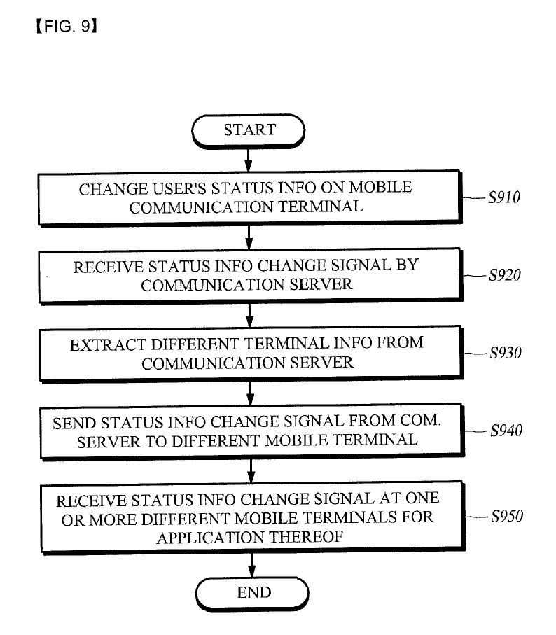

FIG. 9 is a flow chart for explaining a method for the communication server of another aspect to share the status information.

Mobile communication terminal 510, upon receiving a preset status information changing key at its input unit to change the user's own status information 1040, turns the screen to a status information change page for setting incoming information as renewed status information before outputting it as the user's own status information in step S910.

For example, assuming the preset status change key is ‘*’, mobile communication terminal 510 responds to ‘*’ inputted for turning the screen to the status information change page and then sets the inputted information as the renewed status information for outputting the same for user's own status information 1040.

If mobile communication terminal 510 outputted user's own status information 1040 set as the renewed status information, it provides communication server 540 with the status information change signal for transmitting the renewed status information to different terminals preregistered with frequent contacts 1028 in step S920.

Upon receiving the status information change signal from mobile communication terminal 510, communication server 540 extracts one or more different terminals' information that preregistered mobile communication terminal 510 with frequent contacts 1028 in step S940.

Communication server 540 sends the status information change signal to different mobile communication terminal 512 corresponding to the different terminal information extracted via message center 530 in step S940.

One or more different terminals 112, upon receiving a status information change signal from message center 530, controls to change the received member's and others' status information corresponding to the status information change signal in step S950.

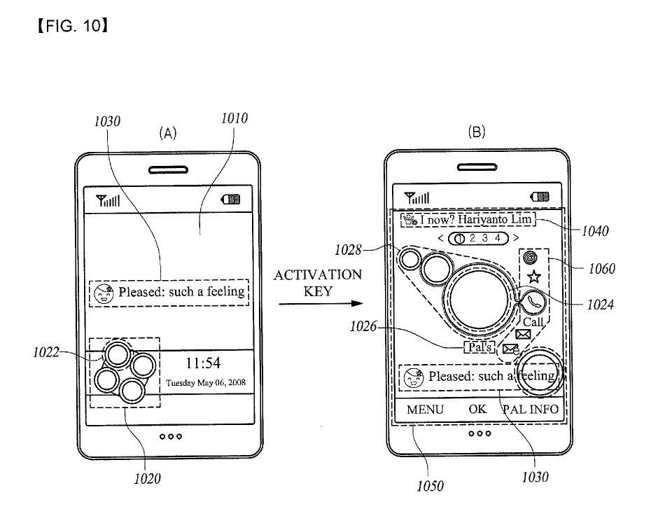

FIG. 10 is an exemplary diagram according to another aspect.

Idle screen 1010 in FIG. 10 at A is adapted to output images that the users set with their own photos, friends' photos, or their preferred images such as those of Internet-downloaded celebrities, cars, etc. or videos.

According to the second aspect, along with the user's set image or video on idle screen 1010, the mobile communication terminal outputs thumbnail group 1020 containing thumbnails 1022 of the corresponding number to a preset number of slots on a certain portion of idle screen 1010.

The position of thumbnail group 1020 in FIG. 10 at A is merely to illustrate the technical idea of the disclosure, and it may be varied within idle screen 10310 by a person skilled in the technical area of the present disclosure without departing from the essential characteristics of the disclosure.

Meanwhile, if the status information change signal is received, the thumbnail corresponding to the status information change signal may be rotated into a preset position as at A of FIG. 10 within thumbnail group 1020 by rotating thumbnail group 1020 clockwise or counterclockwise.

In addition, if the status information change signal is received, the relocated thumbnail at the preset position as A of FIG. 10 may blink temporarily, and the received other's status information 1030 may be temporarily outputted on idle screen 910.

Specifically, received other's status information 1030 may be moved from the left to right and then faded out within a certain time as shown in FIG. 10A and it may comprise combinations of status information image icons, commonly used phrases, and 8-character texts.

In addition, if a preset activation key is inputted to the state of FIG. 10A, active mode screen 1050 as in FIG. 10B is outputted.

Active mode screen 1050 contains member's image information 1024, member's name information 1026, frequent contacts 1028, other's status information 1030, and user's own status information 1040.

Member's image information 1024 may be set using a photograph, avatar, or character, and member's name information 1026 may be an area to output name information of the user registered with frequent contacts 1028, and the name to output may be a preregistered name or nickname in the phone directory of the mobile communication terminal.

Frequent contacts 1028 are a group of members matching in number with the preset slots of thumbnail group 1020, and include the user's preset members.

User's own status information 1040 is an area to display user's own status as in FIG. 10 at B, and if the preset status information change key key) is inputted therein, the terminal may turn the screen to information change page and then set the inputted information as a renewed status information for outputting the same as the user's own status information 1040.

Contact mode icon list 1060 is an area to provide a list of various icons through which the individual user corresponding to the selected member or the received member may be contacted, and if a preset contact mode selection key is inputted therein, a preset operation is performed depending on the contact mode selection key.

For example, assuming the preset contact mode selection key is the ‘up/down arrow keys’, manipulations of which will select an icon of contact mode icon list 1060 including the voice calling icon, SMS icon, MMS icon, and MIM icon.

Specifically, when the user manipulates the ‘up/down arrow keys’ to select the ‘voice calling icon’, the terminal may transmit voice calls to the phone number corresponding to the user's selected member, and when the selection is the ‘SMS icon’, the terminal may transmit SMS to the phone number corresponding to the user's selected member.

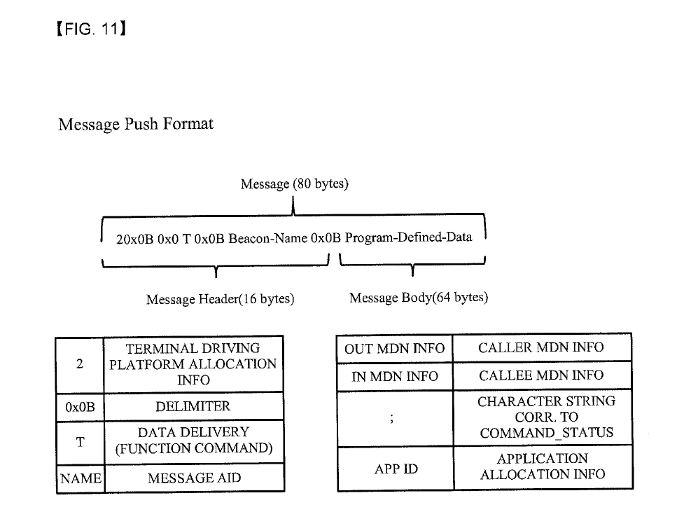

FIG. 11 is an exemplary diagram of the format of a status information change signal according to the second aspect.

As shown, the status information change signal may be made in the form of a message push format.

Specifically, the status information change signal is of the same 80 bytes as SMS, and made of a message header of 16 bytes that contains terminal driving platform allocation information and a message body of 64 bytes containing a character string corresponding to command_status.

Although exemplary aspects of the present disclosure have been described for illustrative purposes, those skilled in the art will appreciate that various changes and modifications are possible, without departing from the essential characteristics of the disclosure. Therefore, exemplary aspects of the present disclosure have been described not for limiting purposes. The scope of the disclosure for protection is to be interpreted by the claims attached, and each and every claim equivalent should be interpreted as being included in the claim scope.

### INDUSTRIAL APPLICABILITY

As described above, when applied to displaying a thumbnail group on an idle screen with sharable status information and a mobile communication terminal, present disclosure outputs a active mode screen indicative of a frequent contacts group of a user's contact member or members who match thumbnail information, provides various added features to help contacting a selected member, provides not only an assistance to contacting the members easier by reordering the information thumbnails displayed on the idle screen based on information on the user's last contacted member but also status information of the selected member and, in response to changes in status information of the contact members preregistered with the frequent contacts group, reorders the information thumbnails displayed on the idle screen so that the status information of the contact members becomes more recognizable, thereby improving the convenience of contacting acquaintances once they are registered with the frequent contacts.

1. A mobile communication terminal comprising:
a storage for storing a communication program;
a terminal controller for executing the communication program;
a display for displaying the communication program executed by the terminal controller; and
an input unit for receiving commands from a user,
wherein the terminal controller, through executing the communication program, controls to display a thumbnail group including frequent contacts on a certain portion of an idle screen, and upon receiving an activation command from the input unit, turn the screen to an active mode screen for displaying graphic image information of the frequent contacts, and in response to the input unit selecting a specific contact, display detailed information on the particular member in the contacts.

2. The mobile communication terminal of claim 1, wherein the terminal controller controls to output a contact mode icon list for the selected member, and in response to a selection of a particular icon from the contact mode icon list, perform a contact mode corresponding to the selected icon for the selected member in the contacts.

3. The mobile communication terminal of claim 1, wherein the detailed information on the particular member includes one or more of name information, phone number information, email information, address information, and status information.

4. The mobile communication terminal of claim 1, further comprising a wireless communication processor, and wherein the terminal controller uses the wireless communication processor to set a received image from a member of the frequent contacts as corresponding member's image information.

5. The mobile communication terminal of claim 1, wherein the terminal controller controls, on the active mode screen, to rotate image information of the selected member in the frequent contacts clockwise or counterclockwise into a preset position to thereby highlight the selected member.

6. The mobile communication terminal of claim 5, wherein the terminal controller, upon receiving a deactivation command from the input unit, controls to turn the active mode screen into the idle screen, moving a matching thumbnail with a member last selected in the active mode screen to a preset position of the thumbnail group, and upon receiving the activation command again from the input unit, display the last selected member in the active mode screen at a preset position on the frequent contacts.

7. The mobile communication terminal of claim 1, wherein the terminal controller controls to additionally display the user's own image information in the active mode screen with a tag included in the same image information to differentiate it from members' image information registered in the frequent contacts.

8. The mobile communication terminal of claim 7, wherein the terminal controller, in response to the user's own image information selected through the input unit, controls to provide functions of image changing or editing, or status changing.

9. The mobile communication terminal of claim 7, wherein the terminal controller, during the idle screen, controls to additionally display the thumbnail of the user's own image information to the thumbnail group.

10. The mobile communication terminal of claim 7, wherein the terminal controller controls to rearrange the image information of the members and the user's own so that a certain display location show image information selected by arrow key inputs or shortcut key inputs received from the input unit.

11. The mobile communication terminal of claim 1, further comprising a wireless communication processor, and wherein the terminal controller controls to receive a signal for a change of status information from a member of the frequent contacts through the wireless communication processor and display information for identifying the status of the member.

12. The mobile communication terminal of claim 11, wherein the terminal controller controls to additionally display the terminal user's own image information along with the status information and, in response to the user changing the user's own status information, send a status change request containing the changed status information to the members of the frequent contacts.

13. The mobile communication terminal of claim 12, wherein the terminal controller controls to send the status change request to a communication server for relaying the same to the members of the frequent contacts.

14. The mobile communication terminal of claim 12, wherein the terminal controller controls to send a status information sharing request to the members of the frequent contacts and send the status change request exclusively to the members from whom approval signals were received.

15. The mobile communication terminal of claim 11, wherein the terminal controller, upon receiving the status information change signals from the members of the frequent contacts, controls to output preset vibrations or alarm sounds or displays animation effects corresponding to the status information change signals.

16. The mobile communication terminal of claim 11, wherein the terminal controller, during the idle screen, controls to rearrange the thumbnail group so that a certain display location show a thumbnail of a member with status information changed to thereby highlight the member.

17. The mobile communication terminal of claim 11, wherein the terminal controller, upon receiving multiple status information change signals, controls to apply them to the active mode screen sequentially.

18. The mobile communication terminal of claim 11, wherein the status information change signal includes identification information for the communication program, identification information of the members with status information changed, and status information.

19. The mobile communication terminal of claim 17, wherein the status information includes one or more of image icons, commonly used phrases, and texts or a combination of these.

20. A method for displaying a thumbnail group comprising:
displaying the thumbnail group including frequent contacts on a certain portion of an idle screen;
upon receiving an activation command from an input unit, turning the screen into an active mode screen for displaying graphic image information of the frequent contacts; and
in response to the input unit selecting a specific contact, displaying detailed information on the particular member in the contacts.

21. The method of claim 20, further comprising:
outputting a contact mode icon list for the selected member; and
in response to a selection of a particular icon from the contact mode icon list, performing a contact mode corresponding to the selected icon for the selected member.

22. The method of claim 20, further comprising:
displaying information for identifying a status of a member.
